(19) United States
(12) Patent Application Publication
(10) Pub. No.: US 2015/0026377 A1
(43) Pub. Date: Jan. 22, 2015

(54) HIGH-SECURITY CARD SLOT MODULE

(71) Applicant: PORTWELL INC., New Taipei City (TW)

(72) Inventor: MING-HSIN TSAI, New Taipei City (TW)

(21) Appl. No.: 13/944,146

(22) Filed: Jul. 17, 2013

(51) Int. Cl. G06F 13/40

(52) U.S. Cl. CPC G06F 13/4068
USPC 710/301

(57) ABSTRACT

A high-security card slot module which is installed on a motherboard and comprises a CFEX slot and a CFEX card: the CFEX card is provided with a networking chip in which network enabling parameters are saved. As such, a user is able to successfully access a network with the CFEX card inserted in the motherboard for upgraded security protection;

moreover, the CFEX card is further provided with a flash memory in which BIOS for booting as secondary backup BIOS is saved for the motherboard with redundant functions.

### BACKGROUND OF THE INVENTION

1. Field of the Invention

The present invention relates to a card slot structure, particularly a high-security card slot module featuring backup safety functions and convenience.

2. Description of the Related Art

The principal IT storage devices or media such as digital camera, recording pen, and music player are mostly based on mature technology for manufacture of compact flash memories, particularly CF (Compact Flash) Cards or high-functioning CFast cards which have been widely adopted in various IT products and even taken as host computers' system hard drives substituting conventional IDE (Integrated Drive Electronics) hard discs because of their multiple advantages including good compatibility, high access speed, high capacity, ultra-low power consumption, compact structure, dust prevention, good vibration strength, and impact resistance.

A conventional CF module (plug-in module) as shown in FIG. 1 for its structure and technology comprises a CF slot 94 which is installed on a motherboard 90 and coupled with a CF card 95, a CPU socket 91 prepared on the motherboard 90 for a CPU to be mounted, extension slots 92 (e.g., CPI bus), a chip 93, and relevant electronic components or circuits. As a high-speed high-stability transmission interface for data access, the conventional CF module does not exert its backup function to support the motherboard, e.g., extension application for data transmission between the CF module and other modules, and deserves to be further reinforced or corrected.

Furthermore, an industrial computer, which features BIOS saved in non-redundant SPI (Serial Peripheral Interface) Flash Rom on a motherboard, lacks secondary backup BIOS and fails in redundant applications. For example, basic troubleshooting for a client motherboard which is not activated or connected to a network is to check destroy of BIOS codes; however, the root cause may not be quickly detected with no redundant assistant detector installed on a conventional motherboard but be found after the SPI Flash IC is removed and remounted on a specific machine for rewriting correct BIOS codes, which may not be available in every client who does not own the machine. It can be seen that the conventional CF module is not an ideal design because time-consuming troubleshooting delays normal operation of a client computer. Thus, how to correct drawbacks related to operation of a conventional motherboard deserves to be further studied by persons skilled in the art.

Having considered defects and unideal structural design of a CF Card in usage and operation for a long period, the inventor offered a solution and manufactured the present invention of a redundant high-security card slot module for the general public and development of the industry.

### SUMMARY OF THE INVENTION

The present invention depends on technical measures comprising a compact flash extension (CFEX) slot and a CFEX card to realize the above purposes: the CFEX slot, which is electrically connected to a motherboard and coupled with the CFEX card, comprises an inward card built-in end and an outward circuit connecting end wherein the card built-in end is internally provided with a terminal pin unit linking the circuit connecting end and classified into ground pins, power pins and functional pins as per realistic functionality; the CFEX card comprises (a) an interface connector that matches the terminal pin unit in which all pins have functions corresponding to those of the interface connector and exerts functions defined as per realistic functionality of the CFEX card, and (b) a networking chip in which network enabling parameters are saved.

In the present invention, the networking chip can be SPI Flash ROM.

In the present invention, the networking chip can be EEPROM.

In the present invention, the CFEX card is provided with a flash memory.

In the present invention, the flash memory allows BIOS for booting to be saved inside.

In the present invention, the flash memory can be SPI Flash Rom.

In the present invention, the flash memory can be EEPROM.

In the present invention, the BIOS codes for booting incorporate password check which is used to verify a Media Access Control (MAC) Address of the networking chip.

In the present invention, the BIOS codes for booting incorporate, password check which is used to verify a user's identity.

In the present invention, the motherboard or the CFEX card is provided with a jump which is switched so that BIOS saved in the CFEX card or in the motherboard is executed during a booting process.

As described hereinbefore, the present invention of a high-security card slot module has the following effects: a user who uses the present invention with the networking chip installed on the CFEX card is able to access a network when the CFEX card is inserted in the motherboard for upgraded security protection; the CFEX card is further provided with a flash memory in which BIOS for booting as secondary backup BIOS is saved for a motherboard with redundant functions; password check designed in BIOS codes is used to verify a user's identity in addition to optimized configurations realized by the networking chip during a booting process; the present invention depends on the secondary backup BIOS to quickly find a root cause resulting in failure of a motherboard during a booting process for effective troubleshooting and better time or cost efficiency in customer services.

For technical features and effects in terms of the present disclosure completely comprehended and recognized, the preferred embodiments and accompanying drawings are thoroughly described hereinafter.

### BRIEF DESCRIPTION OF THE DRAWINGS

FIG. 1 is a schematic view which illustrates structural relationship between a motherboard and a conventional CF card thereon.

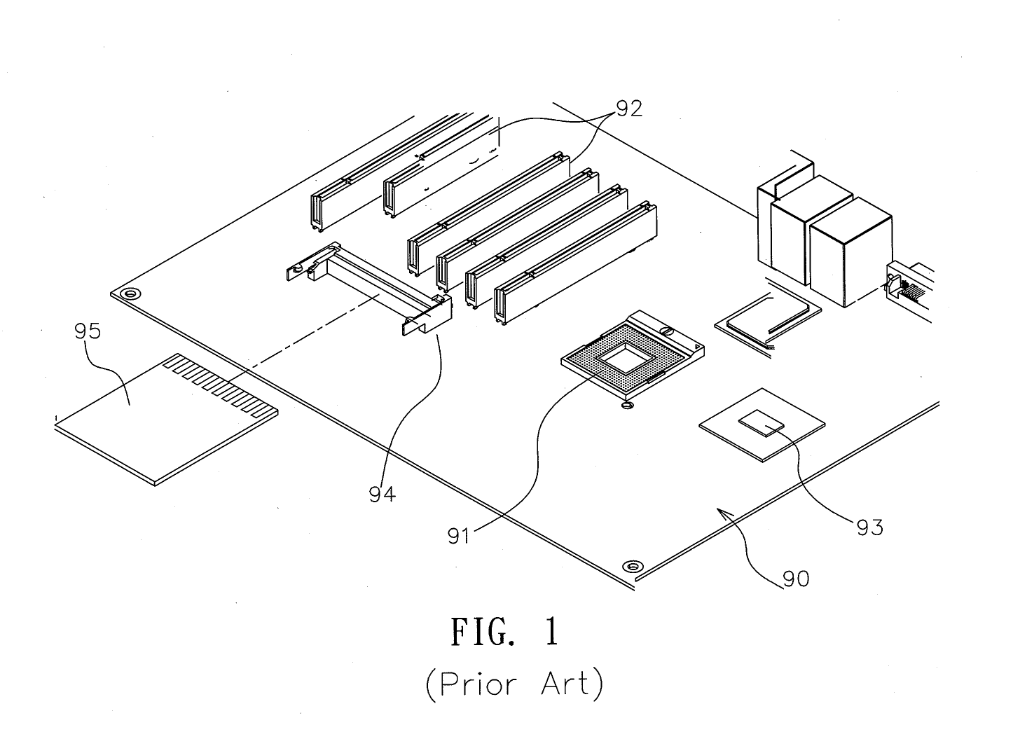

FIG. 2 is a schematic view which illustrates a CFEX slot and a CFEX card in the present invention.

FIG. 3 is a schematic view which illustrates configurations of a terminal pin unit in a CFEX slot of the present invention.

FIG. 4 is a schematic view for structural relationship of the present invention in the first embodiment.

FIG. 5 is a schematic view for structural relationship of the present invention in the second embodiment.

### DETAILED DESCRIPTION OF THE PREFERRED EMBODIMENTS

The present invention provides a high-security card slot module which is installed on a motherboard and comprises: a CFEX slot; a CFEX card on which a networking chip storing network enabling parameters is installed.

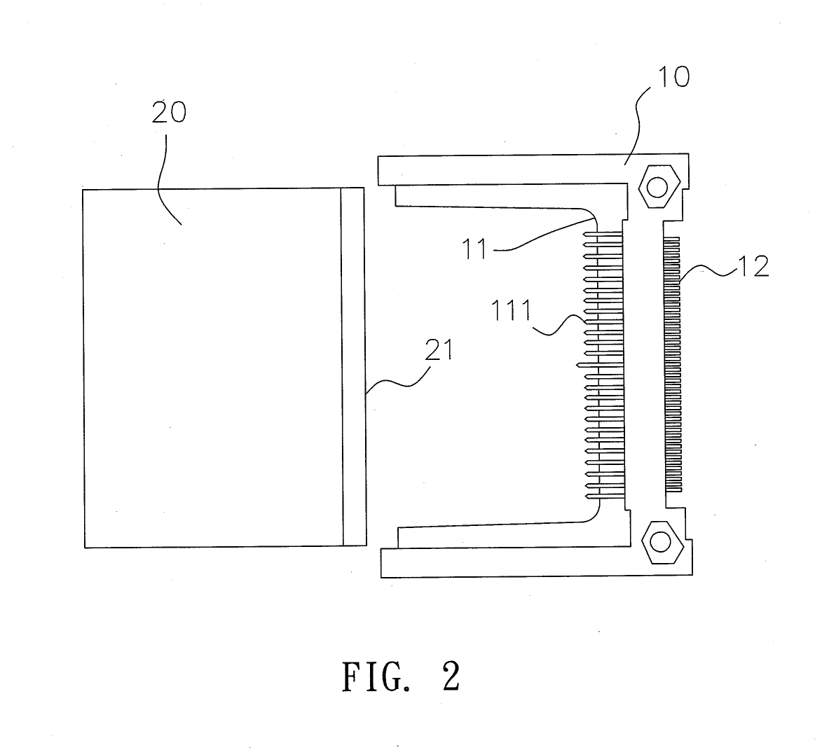

The structure of both the CFEX slot and the CFEX card described as follows is intended for defining the CFEX slot and the CFEX card. Refer to FIG. 2 that illustrates the CFEX slot 10 to be electrically connected to a motherboard has an appearance identical to that of an ordinary CF slot and is taken as a plug-in unit for the CFEX card 20 which communicates with the motherboard stably for signal transmission via the CFEX slot 10. The CFEX slot 10 presented in the present invention comprises an inward card built-in end 11 and an outward circuit connecting end 12: the circuit connecting end 12 is electrically connected to the motherboard; the card built-in end 11 is internally provided with a terminal pin unit 111 which allows one side to link the outward circuit connecting end 12 of the CFEX slot 10.

Specifically, the CFEX card 20 has an interface connector 21 used to match and link the terminal pin unit 111: the interface connector 21 exerts its functions defined as per actual functionality of the CFEX card 20; the terminal pin unit 111 exerts functions of all pins defined as those of the interface connector 21 on the CFEX card 20. Output signals transmitted from the CFEX card 20 are sent to the terminal pin unit 111 at the CFEX slot 10 via the corresponding interface connector 21, the outward circuit connecting end 12 of the CFEX slot 10 via the terminal pin unit 111, and circuits of the motherboard sequentially. Comparatively, input signals transmitted from circuits of the motherboard are forwarded to the inward terminal pin unit 111 via the outward circuit connecting end 12 of the CFEX slot 10 and the corresponding interface connector 21 via the terminal pin unit 111 for completion of signal transmission between the motherboard's circuits and the CFEX card 20.

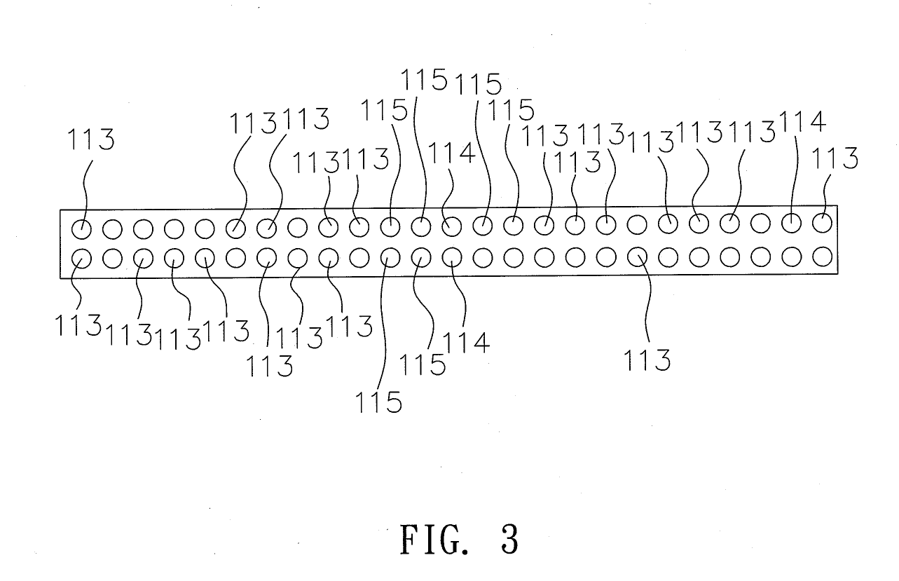

The number of pins available in the terminal pin unit 111 which is held in the card built-in end 11 can be freely decided according to realistic demands. Refer to FIG. 3 which illustrates 50 pins of the terminal pin unit 111 held in the card built-in end 11 in the embodiment. Depending to realistic functions, the terminal pin unit 111 can be defined and classified as ground pins 113, power pins 114 and functional pins 115. A terminal pin which is defined as one of the ground pins 113 implies the circuit connecting end 12 behind the terminal pin is electrically connected to ground circuits on the motherboard; a terminal pin which is defined as one of the functional pins 115 implies the circuit connecting end 12 behind the terminal pin is electrically connected to functional circuits on the motherboard for executing a specific function; a terminal pin which is defined as one of the power pins 114 implies the circuit connecting end 12 behind the terminal pin is electrically connected to power circuits on the motherboard.

The circuit connecting end 12 linking the terminal pin unit 111 of the CFEX slot 10 can be electrically connected to either PCI circuits or PCI Express circuits on the motherboard for more functional applications.

As examples presented in FIG. 3, the pins, e.g., ground pins 113, power pins 114 and functional pins 115, can be adjusted and connected to different circuits for distinct functions as per realistic functionality and demands but not limited to applications in these examples.

It can be seen from above descriptions that the functions of the CFEX card 20 and the CFEX slot 10 in the present invention can be flexibly defined according to pins of the terminal pin unit 111. Moreover, the interface connector 21 based on realistic functionality of the CFEX card 20 has distinct functions at pins corresponding to those of the terminal pin unit 111 so that the CFEX card 20 is internally provided with either a single module or multiple modules, for example, wireless communications module, remote control module, hardware debugging module, and hardware monitoring module, each of which makes both the CFEX card 20 and the CFEX slot 10 exert flexible functions.

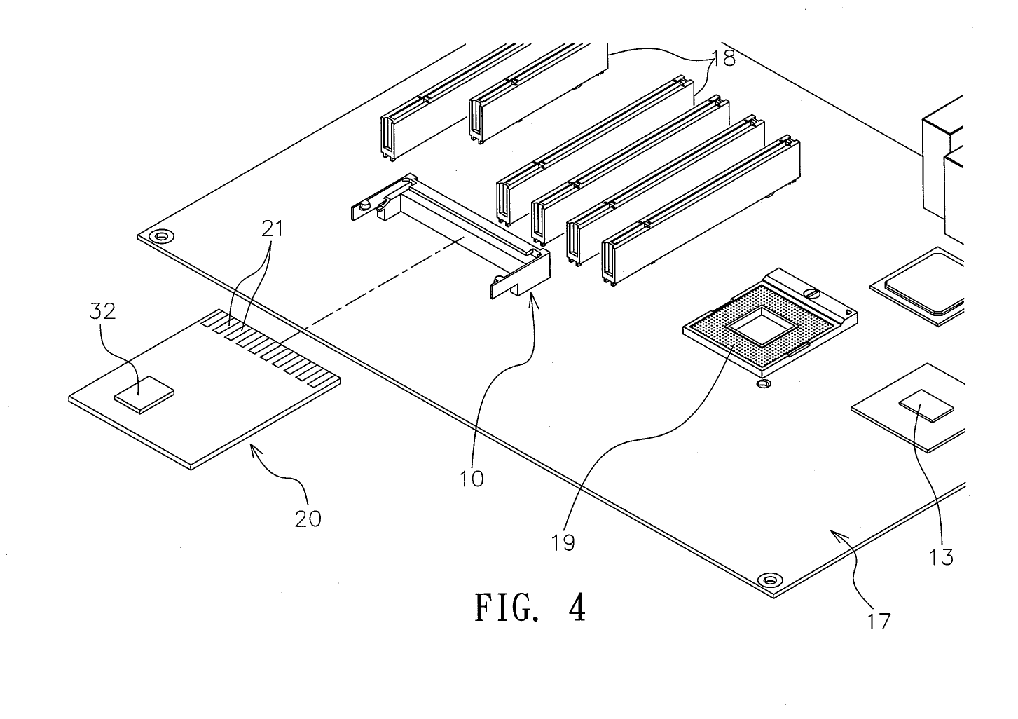

Refer to FIG. 4 which illustrates the present invention of a high-security card slot module in the first embodiment comprises: a CFEX slot 10; a CFEX card 20; a motherboard 17 on which the CFEX slot 10 for accommodating the CFEX card 20 is installed; a CPU socket 19 for connection of a CPU on the motherboard 17; a plurality of extension slots 18 (e.g., CPI bus) on the motherboard 17; a networking chip 13; other relevant electronic components and circuits.

The CFEX slot 10 has circuits electrically connected to the motherboard 17; the CFEX card 20 comprises a networking chip 32 such as SPI (Serial Peripheral Interface) Flash ROM or EEPROM in which network enabling parameters are saved. The networking chip 32 with no network enabling parameters saved will fail in optimized configurations, i.e., failure in network connection. In this embodiment, the networking chip 32 originally installed on the motherboard 17 or a network card is moved to the CFEX card 20 by which a network is successfully accessed when the CFEX card 20 is inserted; however, the network is not accessed with the CFEX card 20 removed for better security protection.

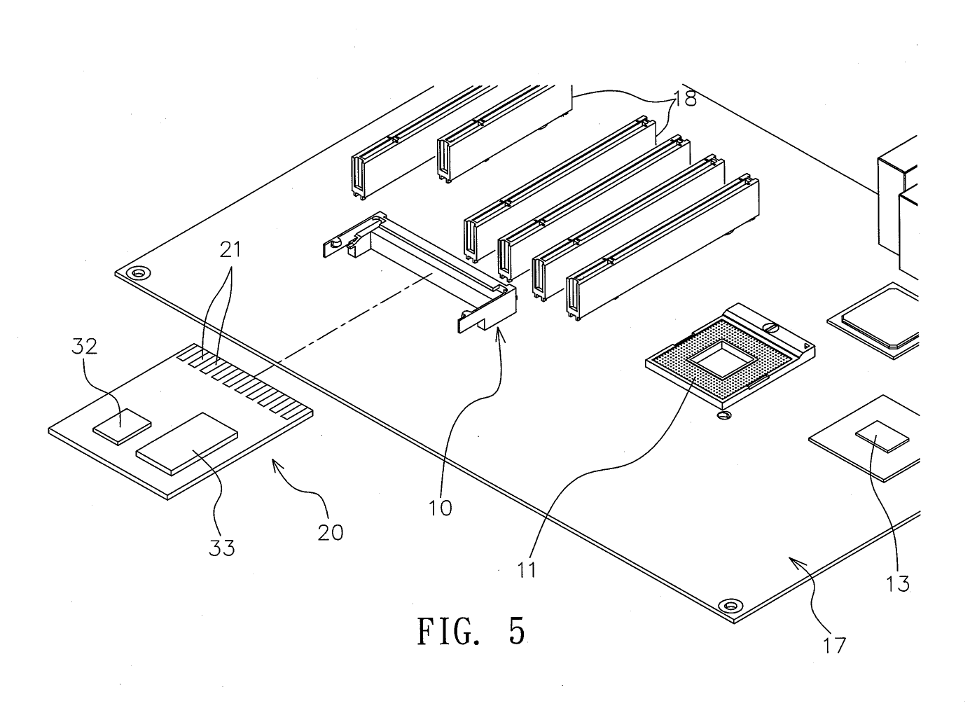

Refer to FIG. 5 which illustrates the present invention of a high-security card slot module in the second embodiment based on the first embodiment and changed to: the CFEX card 20 is provided with a flash memory 33, for example, SPI Flash ROM or EEPROM, in which

BIOS for booting is saved; password check is designed in BIOS codes for determination of the networking chip's Media Access Control Address (MAC Address: a network device's physical address with unique identification numbers) or is based on identification codes, a serial number or a string, for a higher protection level. When the MAC Address is set to a password, the system will check the password with the MAC Address of the networking chip 13 to terminate operation of a computer or disconnect access to a network in case of the password unmatched; when identification codes are set to the password, the system will check the password entered by a user to terminate operation of a computer or disconnect access to a network in case of the password unmatched.

Furthermore, BIOS for booting is also saved in the flash memory 33 which is installed on the CFEX card 20 in this embodiment and taken as secondary backup BIOS of the system for a motherboard with redundant functions. For instance, the motherboard with partial or whole BIOS destroyed is activated with the backup BIOS saved in the flash memory 33; on the other hand, the failed motherboard is also activated with the BIOS saved in the CFEX card 20 by which a root cause, e.g. failure of BIOS codes in the motherboard, is effectively determined.

In the above description, the flash memory 33 in which BIOS for booting is saved can be SPI Flash ROM or EEPROM.

In the preferred embodiments, a motherboard can be activated with BIOS saved in the CFEX card 20 or BIOS saved in the motherboard in a manual or an automatic switching process. In a manual switching process, a user can switch a jump on the motherboard 17 or the CFEX card 20 or depend on preinstalled software for switching available BIOS to boot the system by means of backup BIOS saved in the CFEX card 20 or original BIOS saved in the motherboard; in an automatic switching process, the system will be automatically booted with BIOS saved in the CFEX card 20 at the next booting in case of failure of a normal booting detected.

As described hereinbefore, a user who has the present invention of a high-security card slot module provided with the networking chip on the CFEX card is able to access a network when the CFEX card is inserted in the motherboard for upgraded security protection; the CFEX card is further provided with a flash memory in which BIOS for booting as secondary backup BIOS is saved for a motherboard with redundant functions; password check designed in BIOS codes is used to verify a user's identity in addition to optimized configurations realized by the networking chip during a booting process; the present invention depends on the secondary backup BIOS to quickly find a root cause resulting in failure of a motherboard during a booting process for effective troubleshooting and better time or cost efficiency in customer services.

Accordingly, the present invention significantly meets patentability and is applied for the patent. However, the above descriptions are preferred embodiments which do not limit the scope of the present invention; any equivalent change or improvement in shapes, structure or features without departing from spirit of the present invention should be incorporated in claims herein.

What is claimed is:

1. A high-security card slot module comprising a CFEX slot and a CFEX card:
said CFEX slot is electrically connected to a motherboard and coupled with said CFEX card; and
said CFEX slot comprises an inward card built-in end and an outward circuit connecting end wherein said card built-in end is provided with a terminal pin unit linking said circuit connecting end and classified into ground pins, power pins, and functional pins as per realistic functions; and
said CFEX card comprises an interface connector matching said terminal pin unit and exerting its functions as per realistic functionality of said CFEX card; said terminal pin unit has pins with functions identical to those of corresponding pins of said interface connector at said CFEX card; and
said CFEX card is provided with a networking chip in which network enabling parameters are saved.

2. The high-security card slot module according to claim I wherein said networking chip can be SPI Flash ROM.

3. The high-security card slot module according to claim 1 wherein said networking chip can be EEPROM.

4. The high-security card slot module according to claim 1 wherein said CFEX card is provided with a flash memory.

5. The high-security card slot module according to claim 4 wherein said flash memory stores BIOS for booting.

6. The high-security card slot module according to claim 5 wherein said flash memory can be SPI Flash ROM.

7. The high-security card slot module according to claim 5 wherein said flash memory can be EEPROM.

8. The high-security card slot module according to claim 5 wherein said BIOS codes for booting incorporates password check which is used to verify a Media Access Control Address (MAC Address) of said networking chip.

9. The high-security card slot module according to claim 5 wherein said BIOS codes for booting incorporates password check which is used to verify a user's identity.

10. The high-security card slot module according to claim 5 wherein said motherboard or said CFEX card is provided with a jump which is switched so that BIOS saved in said CFEX card or in said motherboard is executed during a booting process.
